(19) United States
(12) Patent Application Publication
(10) Pub. No.: US 2006/0187147 A1
(43) Pub. Date: Aug. 24, 2006

(54) Plasma display panel, plasma display apparatus, driving apparatus of plasma display panel and driving method of plasma display apparatus

(76) Inventor: Jinhee Jeong, Seongnam-si (KR)

Correspondence Address: MCKENNA LONG & ALDRIDGE LLP, 1900 K STREET, NW, WASHINGTON, DC, 20006, US

(21) Appl. No.: 11/297,479

(22) Filed: Dec. 9, 2005

(30) Foreign Application Priority Data
Feb. 23, 2005 (KR) 10-2005-0014955

(51) Int. Cl. G09G 3/28

(52) U.S. Cl. 345/63

(57) ABSTRACT

The present invention relates to a plasma display apparatus. According to the present invention, the plasma display apparatus comprises a plasma display panel on which images comprised of a frame are displayed by means of a combination of at least one or more sub-fields in which driving pulse are applied to address electrode, scan electrode and sustain electrode in a reset period, an address period and a sustain period, a scan driver for driving the scan electrode and a scan pulse controller for controlling the scan driver to ensure that a difference between the voltage of a set-down pulse applied to the scan electrode in the reset period and a voltage of a scan pulse applied to the scan electrode in the address period, in one of sub-fields of the frame, is different from a difference between the voltage of a set-down pulse and the voltage of a scan pulse for each of the remaining sub-fields.

### CROSS-REFERENCE TO RELATED APPLICATIONS

This Nonprovisional application claims priority under 35 U.S. C. §119(a) on Patent Application No. 10-2005-0014955 filed in Korea on Feb. 23, 2005 the entire contents of which are hereby incorporated by reference.

### BACKGROUND OF THE INVENTION

1. Field of the Invention

The present invention relates to a plasma display apparatus, and more particularly, to a plasma display panel, a plasma display apparatus, a driving apparatus of the panel and a driving method of the apparatus, in which an address discharge and a sustain discharge are stabilized.

2. Background of the Related Art

In a conventional plasma display panel, a barrier rib formed between a front panel and a rear panel forms one unit cell. Each cell is filled with a primary discharge gas, such as neon (Ne), helium (He) or a mixed gas of Ne and He, and an inert gas containing a small amount of xenon. If the inert gas is discharged with a high frequency voltage, it generates vacuum ultraviolet rays. The vacuum ultraviolet rays excite phosphors formed between the barrier ribs, thus generating images. This plasma display panel can be manufactured to be thin, and has been considered one of the next-generation display devices.

FIG. 1, illustrates the construction of a conventional plasma display panel.

Referring to FIG. 1, the plasma display panel comprises a front panel 100 and a rear panel 110. In the front panel 100, a plurality of sustain electrode pairs in which a plurality of scan electrodes 102 and sustain electrodes 103 form pairs is arranged on a front glass 101, i.e., a display surface on which images are displayed. In the rear panel 110, a plurality of address electrodes 113 disposed to cross the plurality of sustain electrode pairs is arranged on a rear glass 111, i.e., a rear surface. The front panel 100 and the rear panel 110 are parallel to each other with a predetermined distance therebetween.

The front panel 100 comprises the pairs of scan electrodes 102 and sustain electrodes 103, which mutually discharge the other and maintain the emission of a cell in one discharge cell. In other words, each of the scan electrode 102 and the sustain electrode 103 each have a transparent electrode “a” made of a transparent ITO material and a bus electrode “b” made of a metal material. The scan electrodes 102 and the sustain electrodes 103 are covered with one or more upper dielectric layers 104 for limiting the discharge current and providing insulation among electrode pairs. A protection layer 105 having magnesium oxide (MgO) deposited thereon is formed on the dielectric layers 104 to facilitate a discharge condition.

In the rear panel 110, barrier ribs 112 of stripe form (or well form), for forming a plurality of discharge spaces, i.e., discharge cells are arranged parallel to one another. A plurality of address electrodes 113, which generate vacuum ultraviolet rays by performing an address discharge, are disposed parallel to the barrier ribs 112. R, G and B phosphors 114 that emit a visible ray for displaying images during an address discharge are coated on the top surface of the rear panel 110. A low dielectric layer 115 for protecting the address electrodes 113 is formed between the address electrodes 113 and the phosphors 114.

A method of generating gray level images in this plasma display panel will now be described with reference to FIG. 2.

FIG. 2 illustrates a method of generating gray level images in the conventional plasma display panel.

As shown in FIG. 2, to represent gray level images in a conventional plasma display panel, one frame is divided into several sub-fields having a different number of emissions. Each sub-field is subdivided into a reset period RPD for initializing the entire cells, an address period APD for selecting a cell to be discharged, and a sustain period SPD for implementing gray levels depending on the number of discharges. For example, to display images with 256 gray levels, a frame period (16.67 ms) corresponding to 1/60 seconds is divided into eight sub-fields SF1 to SF8, as shown in FIG. 2. Each of the eight sub-fields SF1 to SF8 is again divided into a reset period, an address period and a sustain period.

The reset period and the address period of each sub-field are the how for every sub-field. An address discharge for selecting a cell to be discharged is generated due to a voltage difference between the address electrodes and the scan electrodes, i.e., transparent electrodes. In this case, the sustain period increases in the ratio of 2ⁿ (where, n=0, 1, 2, 3, 4, 5, 6, 7) in each sub-field. As described above, since the sustain period is changed in each sub-field, gray level images are represented by controlling the sustain period of each sub-field, i.e., a sustain discharge number.

The method of implementing images gray levels of the plasma display panel is generally classified into a selective writing mode and a selective erasing mode depending on whether a selected discharge cell is excited by an address discharge.

In the selective writing mode, after the entire screen is turned off in the reset period, selected discharge cells are turned on in the address period. In the sustain period, the discharged discharge cells, which are selected by an address discharge, remain turned on, thus displaying images.

In the selective writing mode, the width of a scan pulse is set to be relatively wide, so that a sufficient amount of wall charges are formed within the discharge cells. If the width of the scan pulse becomes too wide, however, problems arise in that the address period becomes too wide and the sustain period contributing to brightness becomes relatively narrow.

In the selective erasing mode, after the entire screen is turned on through a write discharge in the reset period, selected discharge cells are turned off in the address period. Thereafter, in the sustain period, only the discharge cells which were not selected by the address discharge undergo a sustain discharge, thus displaying images.

In such selective erasing mode, the width of the scan pulse is set to be relatively narrow, so that an erase discharge is generated in the discharge cells. That is, in selective erasing mode, the address period can be set to be short by applying a scan pulse with a narrow width. Accordingly, a relatively large amount of time can be allocated to the sustain period, thus, controlling to brightness. The selective erasing mode is however, disadvantageous, in that contrast is too low since the entire screen is turned on in the reset period, i.e., a non-display period.

To overcome the disadvantages of the selective writing and erasing modes, a method in which a selective writing mode and a selective erasing mode are combined has been proposed.

FIG. 3 shows one frame of an exemplary conventional plasma display panel in which sub-fields of a selective writing and a selective erasing mode are comprised in one frame.

As shown in FIG. 3, one frame comprises a selective writing sub-field (WSF) having at least one or more sub-fields, and a selective erasing sub-field (ESF) having at least one or more sub-fields.

The selective writing sub-field (WSF) comprises an m number of sub-fields SF1 to SFm (where, m is a positive integer greater than 0). Each of the first to the (m-1)^{th} sub-fields SF1 to SFm−1 except for an m^{th} sub-field SFm is divided into a reset period for uniformly forming a constant amount of wall charges in cells of the entire screen, a selective writing address period (hereinafter, referred to as a “writing address period”) for selecting on cells using a write discharge, a sustain period for generating a sustain discharge in the selected on cells, and an erase period for erasing wall charges within the cells after the sustain discharge.

The m^{th} sub-field SFm, i.e., the last sub-field of the selective writing sub-field (WSF) is divided into a reset period, a writing address period and a sustain period. The reset period, the writing address period and the erase period of the selective writing sub-field (WSF) are the same in each of sub-fields SF1 to SFm, but the sustain period thereof can be the same or different in a predetermined brightness weight.

The selective erasing sub-field (ESF) comprises an n through m number of sub-fields (SFm+1 to SFn) (where, n is a positive integer greater than m). Each of the (m+1)^{th} to nth sub-fields (SFm+1 to SFn) is divided into a selective erasing address period (hereinafter, referred to as a “erasing address period”) for selecting off cells using an erase discharge, and a sustain period for generating a sustain discharge in on cells. In the sub-fields (SFm+1 to SFn) of the selective erasing sub-field (ESF), the erasing address period is the how, but the sustain period thereof can be the same or different depending upon the relative brightness ratio.

In the method shown in FIG. 3, the address period can be set to be short and the contrast can also be improved in a way to drive the m number of sub-fields in the selective writing mode and the n through m number of the sub-fields in the selective erasing mode. In other words, since one frame comprises the selective erasing sub-field with a short scan pulse, a sufficient sustain period can be secured. Furthermore, since one frame comprises the selective erasing sub-field without a reset period, contrast can be improved.

A driving waveform depending on the driving method of the plasma display panel will be described with reference to FIG. 4 by using the selective writing mode as an example.

FIG. 4 shows an example of a driving waveform in a driving method of a conventional plasma display panel.

As shown in FIG. 4, the plasma display panel is driven with it being divided into a reset period for initializing all of the cells, an address period for selecting cells to be discharged, a sustain period for sustaining the discharge of the selected cells, and an erase period for erasing wall charges within the discharged cells.

In a set-up period of the reset period, a ramp-up waveform (Ramp-up) is applied to all of the scan electrodes at the same time. The ramp up waveform generates a weak dark discharge within the discharge cells of the entire screen. The set-up discharge causes positive wall charges to be accumulated on the address electrodes and the sustain electrodes and negative wall charges to be accumulated on the scan electrodes.

In a set-down period of the reset period, after the ramp-up waveform is applied, a ramp-down waveform (Ramp-down), which starts falling from a positive voltage lower than a peak voltage of the ramp-up waveform down to a predetermined voltage level lower than a ground (GND) level voltage, generates a weak erase discharge within cells, thereby sufficiently erasing wall charges excessively formed on the scan electrodes. The set-down discharge causes wall charges of a degree that a stable address discharge will occur to uniformly remain within the cells.

In the address period, while a negative scan pulse is sequentially applied to the scan electrodes, a positive data pulse is applied to the address electrodes in synchronization with the scan pulse. As the voltage difference between the scan pulse and the data pulse and a wall voltage generated in the reset period are added together, an address discharge is generated within the discharge cells to which the data pulse is applied. Wall charges of the degree in which a discharge can occur when a sustain voltage (Vs) is applied are formed within cells selected by an address discharge. The sustain electrode is supplied with a positive polarity voltage (Vz) such that an erroneous discharge is not generated between the sustain electrode and the scan electrodes by reducing between the sustain electrode and the scan electrodes during the set-down period and the address period.

In the sustain period, a sustain pulse (sus) is alternately applied to the scan electrodes and the sustain electrode. In cells selected by an address discharge, a sustain discharge, i.e., a display discharge that is generated between the scan electrodes and the sustain electrodes whenever a sustain pulse is applied as the wall voltage within the cell and the sustain pulse are added.

After the sustain discharge finishes, in the erase period, a voltage of an erase ramp waveform (Ramp-ers) with a narrow pulse width and a low voltage level is applied to the sustain electrodes, thereby erasing wall charges remaining within the cells of the entire screen.

In the plasma display panel driven according to this driving waveform, in sub-fields of all of the frames, the difference between the lowest voltage of a set-down pulse applied to the scan electrodes in the reset period and a voltage of a scan pulse (Vsc) applied to the scan electrodes in the address period is the same. The difference between the lowest voltage of the set-down pulse and the voltage of the scan pulse in the related art will be described with reference to FIG. 5.

FIG. 5 illustrates the difference between the lowest voltage of a set-down pulse, which is applied in a reset period, and a voltage of a scan pulse, which is applied in an address period, in the driving method of the conventional plasma display panel.

As shown in FIG. 5, in the driving method of the conventional plasma display panel, the difference between the lowest voltage of a set-down pulse applied in the reset period and a voltage of a scan pulse applied in the address period is the same in every sub-field. In other words, the difference between the lowest voltage of the set-down pulse and the voltage of the scan pulse in sub-fields with a low gray level because of their relatively low weight and sub-fields-implementing a high gray level because of its relatively high weight is the same.

The difference between the lowest voltage of the set-down pulse and the voltage of the scan pulse is one of the most important factors affecting the generation of wall charges within the discharge cells. The greater the difference between a voltage of the scan pulse (Vsc), which inversely falls from the end of the set-down pulse to a scan reference voltage, and a voltage at the end of the set-down pulse, i.e., the lowest voltage of the set-down pulse is increased, the greater the amount of wall charges generated within the discharge cells.

In the related art, however, the difference between the lowest voltage of the set-down pulse and the voltage of the scan pulse is the same in all of the sub-fields regardless of their weight. Accordingly, there is a high probability that an unstable address discharge will occur in an initial sub-field, i.e., a sub-field with a relatively low weight. As a result, address jitter deteriorates.

In sub-fields with a low gray level because of its relatively low weight value as described above, an address discharge will be unstable and the number of sustain pulses will be low, compared to sub-fields with a high gray level. Accordingly, there is a possibility that an unstable sustain discharge occur since the amount of wall charges accumulated within discharge cells is insufficient for the sustain discharge due to the unstable address discharge. In view of such sustain discharge characteristic, the distribution of wall charges within discharge cells must be set to allow for a stable sustain discharge by generating a stable address discharge in the address period.

In the related art, however, the difference between the lowest voltage of the set-down pulse and the voltage of the scan pulse is the same in all of the sub-fields regardless of their weight. Therefore, the distribution of wall charges within discharge cells after an address discharge is insufficient in an initial sub-field, which has a high probability that an unstable address discharge may occurs, i.e., a sub-field with a relatively weight. Accordingly, a problem arises in that an unstable sustain discharge occurs, a sustain discharge is not generated at all or the like.

In the driving method employing a combination of the selective writing sub-fields and the selective erasing sub-fields as described above in FIG. 3, the difference between the lowest voltage of the set-down pulse and the voltage of the scan pulse is the same in the selective erasing sub-fields in which a relatively small amount of wall charges are generated because of a small reset pulse and the selective writing sub-fields in which a relatively great amount of wall charges are generated in the reset period because of a small reset pulse, in the reset period. Accordingly, in the selective erasing sub-fields in which a relatively small amount of wall charges are generated because of a small reset pulse as described above, there is a high probability that an unstable address discharge may occur compared to the selective writing sub-fields. Accordingly, a problem arises in that address jitter deteriorates or an unstable sustain discharge occurs in the selective erasing sub-field compared to the selective writing sub-field.

### SUMMARY OF THE INVENTION

Accordingly, an object of the present invention is to solve at least the problems and disadvantages of the background art.

An objection of the present invention is to provide a plasma display apparatus in which a driving pulse applied in a set-down period of a reset period and an address period is improved.

To achieve these and other advantages and in accordance with the purpose of the present invention, as embodied and broadly described, there is provided a plasma display apparatus comprising: a plasma display apparatus comprising: a plasma display panel on which images comprised of a frame are displayed by means of a combination of at least one or more sub-fields in which driving pulse are applied to address electrode, scan electrode and sustain electrode in a reset period, an address period and a sustain period, a scan driver for driving the scan electrode and a scan pulse controller for controlling the scan driver to ensure that a difference between the voltage of a set-down pulse applied to the scan electrode in the reset period and a voltage of a scan pulse applied to the scan electrode in the address period, in one of sub-fields of the frame, is different from a difference between the voltage of a set-down pulse and the voltage of a scan pulse for each of the remaining sub-fields.

The voltage of scan pulse is constant.

The voltage of set-down pulse is the lowest voltage.

The difference between the voltage of the set-down pulse and the voltage of the scan pulse is controlled according to a gray value of a subfield.

The difference between the voltage of the set-down pulse and the voltage of the scan pulse in any subfield of three low gray level subfields is greater than the difference between the voltage of the set-down pulse and the voltage of the scan pulse in remaining subfields.

The difference between the voltage of the set down pulse and the voltage of the scan pulse is controlled according to a number of sustain pulse in a subfield.

The number of the sustain pulse in the subfield is 50% or less of a total number of sustain pulses used in one frame

The number of the sustain pulse in the subfield is 30% or less of a total number of sustain pulses used in one frame.

The sub-fields of the frame are divided into two subfield groups, wherein the scan pulse controller controls a difference between the voltage of a set-down pulse and the voltage of a scan pulse in a sub-field of at least one of the two subfield groups, to be greater than a difference between the voltage of the set-down pulse and the voltage of the scan pulse for each of the remaining sub-fields of the other group.

Each of the two subfield groups comprise three low gray level subfields

In a group in which a difference between the voltage of a set-down pulse and the voltage of a scan pulse is great, of the two subfield groups, the scan pulse controller controls a difference between the voltage of a set-down pulse and the voltage of a scan pulse, in one of sub-fields, to be different from the difference between lowest voltage of a set-down pulse and the voltage of a scan pulse if the remaining sub-fields.

In a group in which a difference between the voltage of a set-down pulse and a voltage of a scan pulse is great, of the two subfield groups, the scan pulse controller controls a difference between the voltage of a set-down pulse and the voltage of a scan pulse to be different on a sub-field basis.

In a group in which a difference between the voltage of a set-down pulse and the voltage of a scan pulse is different on a sub-field basis, the scan pulse controller controls a difference between the voltage of a set-down pulse and the voltage of a scan pulse to increase as the weight decreases.

The predetermined number of sub-fields comprises sub-fields in which sustain pulses are allowed, and wherein the number of the sustain pulses allowed in the sub-fields is less than a critical number.

The critical number is 50% or less, of a total number of sustain pulses used in one frame.

The critical number is 30% or less, of the total number of sustain pulses used in one frame.

The frame comprises a selective writing sub-field and a selective erasing sub-field, wherein the scan pulse controller controls a difference between the voltage of a set-down pulse and the voltage of a scan pulse in the selective erasing sub-field of the sub-fields of the frame, to be greater than a difference between the voltage of a set-down pulse and the voltage of a scan pulse in the selective writing sub-field.

The frame comprises a plurality of selective erasing sub-fields, wherein the scan pulse controller controls a difference between the voltage of a set-down pulse and the voltage of a scan pulse applied to the scan electrodes in the address period to be the same in the plurality of selective erasing sub-fields.

The frame comprises a plurality of selective erasing sub-fields, wherein the scan pulse controller controls a difference between the voltage of a set-down pulse and the voltage of a scan pulse in the address period, in one of the plurality of selective erasing sub-fields, to be different from a difference between the voltage of a set-down pulse and the voltage of a scan pulse of the remaining selective erasing sub-fields.

The frame comprises a plurality of selective erasing sub-fields, wherein the scan pulse controller controls a difference between the voltage of a set-down pulse and the voltage of a scan pulse to be different for every sub-field in the plurality of selective erasing sub-fields.

The scan pulse controller controls a difference between the voltage of a set-down pulse and the voltage of a scan pulse to increase as the weight decreases in order of a higher weight in the plurality of selective erasing sub-fields.

The present invention has an effect in that an address discharge and a sustain discharge will be stabilized upon driving of the plasma display apparatus.

### BRIEF DESCRIPTION OF THE DRAWINGS

Further objects and advantages of the invention can be more fully understood from the following detailed description taken in conjunction with the accompanying drawings in which:

FIG. 1 illustrates the construction of a conventional plasma display panel;

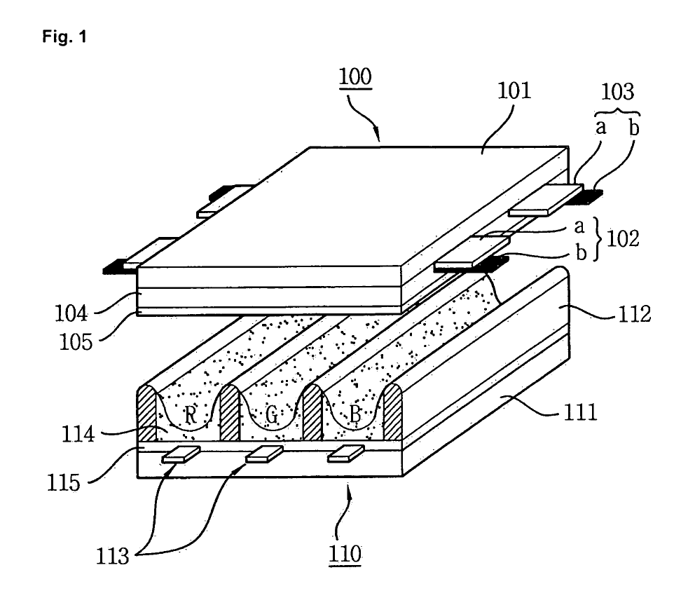

FIG. 2 illustrates a method of implementing gray level images in the conventional plasma display panel;

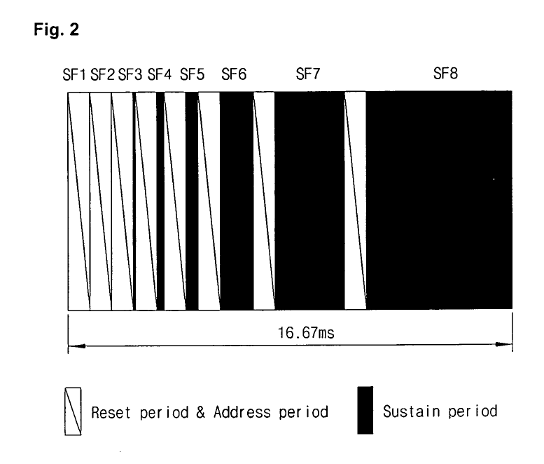

FIG. 3 shows one frame of an exemplary conventional plasma display panel in which sub-fields of selective writing and selective erasing mode are comprised in one frame;

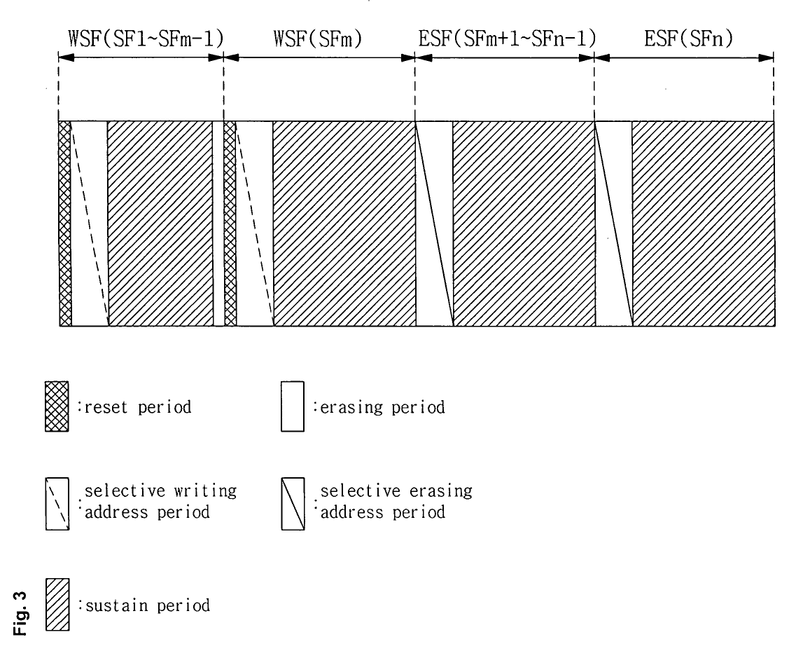

FIG. 4 shows an example of a driving waveform in a driving method of the conventional plasma display-panel;

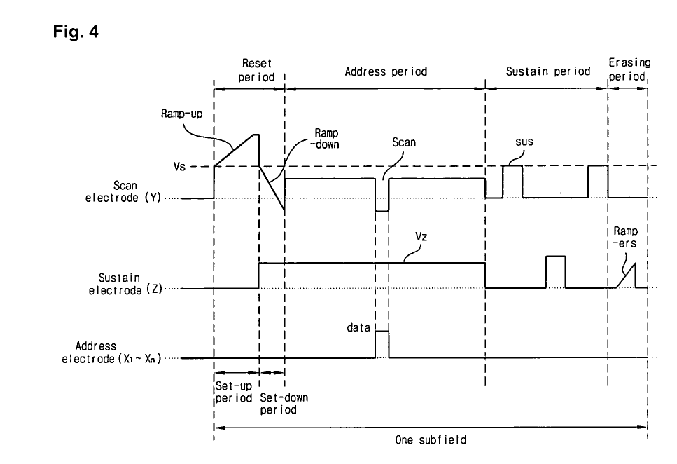

FIG. 5 illustrates the difference between the lowest voltage of a set down pulse, which is applied in a reset period, and the voltage of a scan pulse, which is applied in an address period, in the driving method of the conventional plasma display panel;

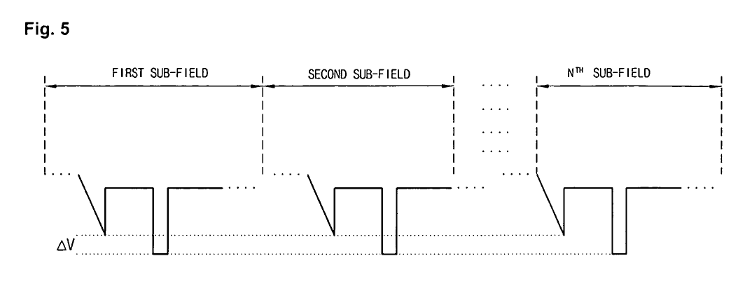

FIG. 6 shows the construction of a plasma display apparatus according to the present invention;

FIG. 7 illustrates an embodiment of a driving method of a plasma display panel according to the present invention;

FIG. 8 illustrates an example of a method of selecting a sub-field in which a difference between the lowest voltage of a set-down pulse and a voltage of a scan pulse is greater than the difference between lowest voltage of a set-down pulse and the voltage of a scan pulse of other sub-fields;

FIG. 9 illustrates a method of driving one frame with it being divided into two sub-field groups;

FIG. 10 illustrates the difference between the lowest voltage of a set-down pulse and the voltage of a scan pulse within one sub-field group;

FIG. 11 illustrates a driving method when sub-fields of one frame comprise both sub-fields of the selective writing mode and sub-fields of the selective erasing mode; and

FIG. 12 illustrates the difference between the lowest voltage of a set-down pulse and the voltage of a scan pulse between selective erasing sub-fields.

### DETAILED DESCRIPTION OF THE PREFERRED EMBODIMENT

The present invention will now be described in detail in connection with preferred embodiments with reference to the accompanying drawings.

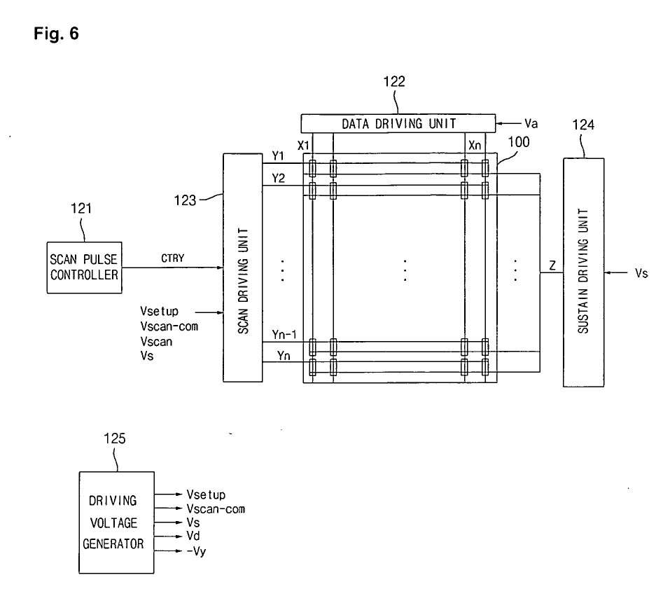

FIG. 6 shows the construction of a plasma display apparatus according to the present invention.

As shown in FIG. 6, the plasma display apparatus according to the present invention comprises a plasma display panel 100 on which images comprised of frames are displayed by means of a combination of at least one or more sub-fields in which driving pulses are applied to address electrodes X1 to Xm, scan electrodes Y1 to Yn and a sustain electrode Z in a reset period, an address period and a sustain period, a data driver 122 for applying data to the address electrodes X1 to Xm formed in a rear panel (not shown) of the plasma display panel 100, a scan driver 123 for driving the scan electrodes Y1 to Yn, a sustain driver 124 for driving the sustain electrodes Z, i.e., a common electrode, a scan pulse controller 121 for controlling the scan driver 123 when the plasma display panel 100 is driven, and a driving voltage generator 125 for applying driving voltages necessary for the drivers 122, 123 and 124, respectively.

The above-described plasma display panel 100 comprises a front panel (not shown) and a rear panel (not shown), which are disposed parallel to each other with a predetermined distance therebetween. A number of electrodes, such as the scan electrodes Y1 to Yn and the sustain electrode Z, are formed in pairs on the front panel. The address electrodes X1 to Xm are disposed to intersect the scan electrodes Y1 to Yn and the sustain electrode Z are formed on the rear panel.

Data, which undergoes an inverse gamma correction and error diffusion through an inverse gamma correction circuit (not shown), an error diffusion circuit (not shown) and the like and are then mapped to the respective sub-fields by a sub-field mapping circuit (not shown), is supplied to the data driver 122. The data driver 122 samples and latches the data in response to a timing control signal (CTRX) and then supplies the data to the address electrodes X1 to Xm.

The scan driver 123 supplies a ramp-up waveform (Ramp-up) and a ramp-down waveform (Ramp-down) to the scan electrodes Y1 to Yn during the reset period under the control of the scan pulse controller 121. The scan driver 123 sequentially supplies a scan pulse (Sp) of a scan voltage (−Vy) to the scan electrodes Y1 to Yn during the address period, and supplies a sustain pulse (sus) whose width is controlled according to brightness weight, i.e., the gray level value of the scan electrodes Y1 to Yn during the sustain period, under the control of the scan pulse controller 121.

The set-down pulse and the scan pulse (Sp) are applied to the scan electrodes Y1 to Yn in such a way that the difference between the lowest voltage of the set-down pulse applied to the scan electrodes in the reset period and the voltage of the scan pulse (Sp) applied to the scan electrodes in the address period, in sub-fields implementing a low gray level, is greater than the difference between the lowest voltage of the set-down pulse applied to the scan electrodes in the reset period and the voltage of the scan pulse (Sp) applied to the scan electrodes in the address period of the remaining sub-fields. In this case, the term “low gray level” refers to a gray level value in sub-fields having a relatively low brightness weight where gray levels are represented with a brightness weight being given every sub-field when the plasma display panel 100 is driven with it being divided into a plurality of sub-fields.

The sustain driver 124 applies a bias voltage equal to the sustain voltage (Vs) to the sustain electrodes Z during the period where the ramp-down waveform (Ramp-form) is generated and during the address period and also applies a sustain pulse (sus) to the sustain electrodes Z while operating in conjunction with the scan driver 123 during the sustain period.

The scan pulse controller 121 generates an operating timing of the scan driver 123 and a timing control signal (CTRY) for controlling synchronization in the reset period, the address period and the sustain period, and applies the timing control signal (CTRY) to the scan driver 123, thus controlling the, scan driver 123. In particular, the scan pulse controller 121 applies a control signal, which controls the difference between the lowest voltage of a set-down pulse applied to the scan electrodes in the reset period and the voltage of a scan pulse applied to the scan electrodes in the address period, in sub-fields with a low gray level among a number of sub-fields, to be greater than the difference between lowest voltage of a set-down pulse and the voltage of a scan pulse of the remaining sub-fields to the scan driver 123. In other words, the scan pulse controller 121 applies the control signal to the scan driver 123 so that a difference between the lowest voltage of a set-down pulse applied to the scan electrodes in the reset period and a voltage of a scan pulse applied to the scan electrodes in the address period, in sub-fields implementing a low gray level, to be greater than the difference between lowest voltage of a set-down pulse and the voltage of a scan pulse of the remaining sub-fields.

The data control signal (CTRX) comprises a sampling clock for sampling data, a latch control signal, and a switch control signal for controlling an on/off time of an energy recovery circuit and a driving switch element. A scan control signal (CTRY) comprises a switch control signal for controlling an on/off time of an energy recovery circuit and a driving switch element within the scan driver 123. A sustain control signal (CTRZ) comprises a switch control signal for controlling an on/off time of an energy recovery circuit and a driving switch element within the sustain driver 124.

The driving voltage generator 125 generates a set-up voltage (Vsetup), a common scan voltage (Vscan-com), a scan voltage (−Vy), a sustain voltage (Vs), a data voltage (Vd) and the like. These driving voltages may vary depending upon the composition of a discharge gas or the structure of the discharge cell.

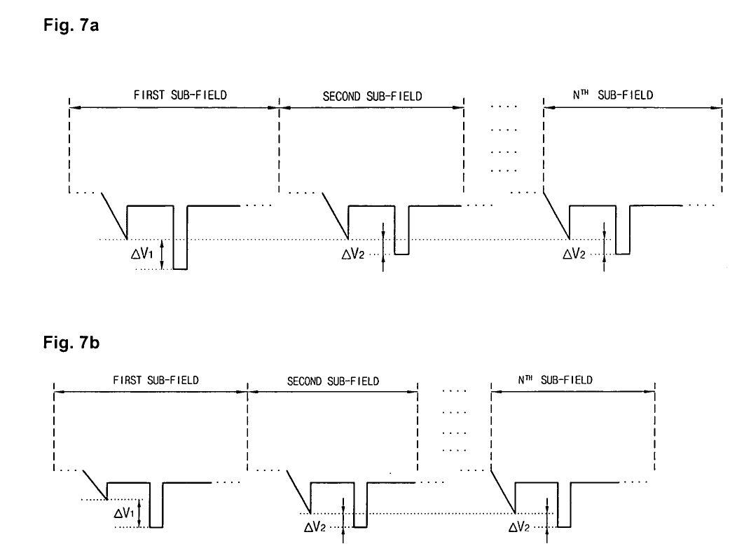

An embodiment of a driving method performed by the plasma display apparatus according to the present invention will be described with reference to FIGS. 7a and 7b.

FIGS. 7a and 7b illustrates an embodiment of a driving method of the plasma display panel according to the present invention.

As shown in FIGS. 7a and 7b, in the driving method of the plasma display panel according to the present invention, a difference between the lowest voltage of a set-down pulse applied to the scan electrodes in a reset period and the voltage of a scan pulse applied to the scan electrodes in an address period, in one selected sub-field of a plurality of sub-fields constituting a frame, is set to be different from a difference between the lowest voltage of a set-down pulse applied to the scan electrodes in a reset period and the voltage of a scan pulse applied to the scan electrodes in an address period, in the remaining sub-fields that are not selected, of the plurality of sub-fields constituting the frame.

The method of setting a difference between the lowest voltage of a set-down pulse and the voltage of a scan pulse in a selected sub-field to be different from a difference between the lowest voltage of a set-down pulse and the voltage of a scan pulse in non-selected sub-fields includes setting the lowest voltage of a set-down pulse applied to the scan electrodes in a reset period of the entire sub-fields to be constant and setting voltages of scan pulses applied to the scan electrodes in an address period of a selected sub-field to be different from each other, as shown in FIG. 7a, and setting the voltage of a scan pulse applied to the scan electrodes in an address period of the entire sub-fields to be constant and setting the lowest voltages of set-down pulses applied to the scan electrodes in a reset period of a selected sub-field to be different from each other, as shown in FIG. 7b.

In addition, a difference between the lowest voltage of a set-down pulse and the voltage of a scan pulse in a selected sub-field can be set to be different from a difference between the lowest voltage of a set-down pulse and the voltage of a scan pulse in non-selected sub-fields by setting the lowest voltage of the set-down pulse and the voltage of the scan pulse to be different at the same time.

In FIGS. 7a and 7b, assuming that a difference between the lowest voltage of a set-down pulse and the voltage of a scan pulse in a first sub-field is ΔV1 and a difference between the lowest voltage of a set-down pulse and the voltage of a scan pulse in sub-fields ranging from a second sub-field to a nth sub-field is ΔV2, the relationship ΔV1>ΔV2 is established between ΔV1 and ΔV2.

The reason why the difference between the lowest voltage of the set-down pulse and the voltage of the scan pulse in the first sub-field is set to be greater than the difference between lowest voltage of a set-down pulse and the voltage of a scan pulse of the remaining sub-fields in FIG. 7 as described above, is that there is a high probability that an address discharge may become unstable in an initial sub-field and address jitter will deteriorate to make the discharge relatively unstable. For this reason, to stabilize the address discharge in the first sub-field, the difference between the lowest voltage of a set-down pulse and the voltage of a scan pulse the first sub-field is set to be greater than the difference between lowest voltage of a set-down pulse and the voltage of a scan pulse of the remaining sub-fields.

The reason why the difference between the lowest voltage of the set-down pulse and the voltage of the scan pulse in the first sub-field is set to be greater than the difference between lowest voltage of a set-down pulse and the voltage of a scan pulse of the remaining sub-fields is that the first sub-field is a sub-field with a low gray level and thus has the number of sustain pulses, which is smaller than the difference between lowest voltage of a set-down pulse and the voltage of a scan pulse of the remaining sub-fields with a high gray level, i.e., from a second sub-field to a n^{th} sub-field. Accordingly, there is a possibility that a sustain discharge may become unstable since the amount of wall charges accumulated within discharge cells decreases. As a result, the difference between the lowest voltage of a set-down pulse and a voltage of a scan pulse in the first sub-field is set to be greater than the difference between lowest voltage of a set-down pulse and the voltage of a scan pulse of the remaining sub-fields so that a stable address discharge is generated in the address period. This sets the distribution of the wall charges within the discharge cells to be more advantageous for the sustain discharge.

As shown and described in FIG. 7, the difference between the lowest voltage of a set-down pulse and the voltage of a scan pulse in a first sub-field is set to be greater than the difference between lowest voltage of a set-down pulse and the voltage of a scan pulse of the remaining sub-fields. However, the difference between the lowest voltage of a set-down pulse and the voltage of a scan pulse in a first sub-field and a second sub-field or a second sub-field and a third sub-field can be set to be greater than the difference between lowest voltage of a set-down pulse and the voltage of a scan pulse of the remaining sub-fields.

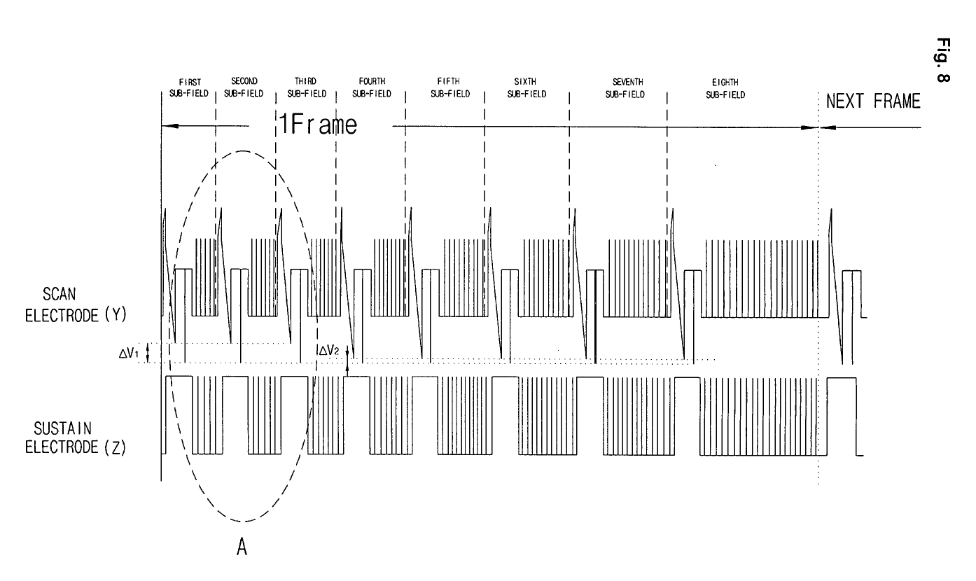

As described above, a sub-field in which the difference between the lowest voltage of a set-down pulse and the voltage of a scan pulse is set to be greater than the difference between lowest voltage of a set-down pulse and the voltage of a scan pulse of the remaining sub-fields can be selected according to its weight. A method of selecting the sub-field will be described with reference to FIG. 8.

FIG. 8 illustrates an example of a method of selecting a sub-field in which the difference between the lowest voltage of a set-down pulse and the voltage of a scan pulse is greater than the difference between lowest voltage of a set-down pulse and the voltage of a scan pulse of other sub-fields.

As shown in FIG. 8, an exemplary method of selecting a sub-field in which a difference between the lowest voltage of a set-down pulse and a voltage of a scan pulse is greater than the difference between lowest voltage of a set-down pulse and the voltage of the scan pulse of the remaining sub-fields comprises selecting a sub-field from a sub-field having the lowest weight, of the sub-fields comprised in a frame, to a predetermined number of sub-fields in increasing order of weight, and setting a difference between the lower voltage of a set-down pulse applied to the scan electrodes in the reset period and a voltage of a scan pulse applied to the scan electrodes in the address period in the selected sub-field to be greater than the difference between lowest voltage of a set-down pulse and the voltage of a scan pulse of the remaining sub-fields.

In this case, the predetermined number of sub-fields is from a sub-field having the lowest weight to a predetermined number of sub-field such as a third sub-field in increasing order of weight, as shown in FIG. 8. The reason why a sub-field in which the difference between the lowest voltage of a set-down pulse and the voltage of a scan pulse is set to be greater than the difference between lowest voltage of a set-down pulse and the voltage of a scan pulse of the remaining sub-fields is set from a sub-field having the lowest weight, i.e., a first sub-field to a third sub-field in increasing order of weight is that sub-fields from the first sub-field to the third sub-field are sub-fields with a low weight in order to implement a relatively low gray level. In FIG. 8, from the first sub-field to the third sub-field in increasing order weight is set to a region “A”.

As described above, a sub-field in which the difference between the lowest voltage of a set-down pulse and the voltage of a scan pulse us set to be greater than the difference between lowest voltage of a set-down pulse and the voltage of a scan pulse of the remaining sub-fields can be decided in terms of the number of sustain pulses in the sustain period of the sub-field. In other words, a sub-field having a small number of sustain pulses is a sub-field with a low gray level, and a sub-field having a large number of sustain pulses is a sub-field with a high gray level. As described above, since the weight of a sub-field depends on the number of sustain pulses, the reference to select a sub-field in which the difference between the lowest voltage of a set-down pulse and the voltage of a scan pulse is set to be greater than the difference between lowest voltage of a set-down pulse and the voltage of a scan pulse of the remaining sub-fields is set as the number of sustain pulses. The difference between the lowest voltage of a set-down pulse and the voltage of a scan pulse in a sub-field having a smaller number of sustain pulses than the set number of the sustain pulses as described above is set to be greater than the difference between lowest voltage of a set-down pulse and the voltage of a scan pulse of the remaining sub-fields.

The reference to select a sub-field in which the difference between the lowest voltage of a set-down pulse and the voltage of a scan pulse is set to be greater than the difference between lowest voltage of a set-down pulse and the voltage of a scan pulse of the remaining sub-fields can comprise setting the difference between the lowest voltage of a set-down pulse and the voltage of a scan pulse in a corresponding sub-field when the number of sustain pulses is smaller than a critical number is set to be greater than the difference between lowest voltage of a set-down pulse and the voltage of a scan pulse of the remaining sub-fields. In this case, the critical number can be 50% or less, of the total number of sustain pulses also used in one frame. The critical number can also be 30% or less of the total number of sustain pulses used in one frame.

For example, in the case where a total of 1000 sustain pulses are used in one frame, a sub-field that uses sustain pulses of 30% or less of the total number of sustain pulses used in one frame, i.e., 300 is selected. The difference between the lowest voltage of a set-down pulse and the voltage of a scan pulse in the selected sub-field is set to be greater than the difference between lowest voltage of a set-down pulse and the voltage of a scan pulse of the remaining sub-fields.

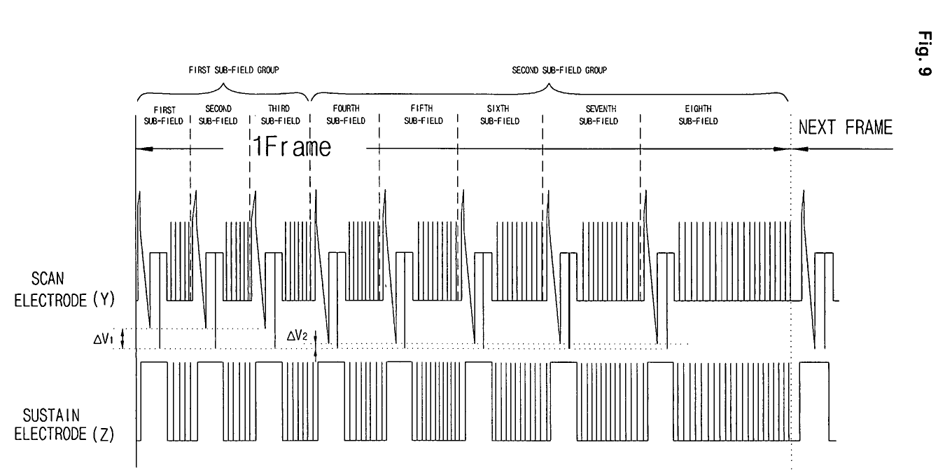

Unlike the above, sub-fields of one frame can be divided into two sub-field groups, and the difference between the lowest voltage of a set-down pulse and the voltage of a scan pulse in a sub-field of one of the two sub-field groups can be set to be greater than the difference between lowest voltage of a set-down pulse and the voltage of a scan pulse of the other sub-field group. This method will be described with reference to FIG. 9.

FIG. 9 illustrates a method of driving one frame with it being divided into two sub-field groups.

As shown in FIG. 9, the sub-fields of one frame are divided into two sub-field groups, and the difference between the lowest voltage of a set-down pulse applied to the scan electrodes in the reset period and the voltage of a scan pulse applied to the scan electrodes in the address period, in a sub-field of one of the two sub-field groups, is set to be greater than the difference between lowest voltage of a set-down pulse and the voltage of a scan pulse of the other sub-field group. For example, as shown in FIG. 9, one frame is divided into a first sub-field group and a second sub-field group, and the difference between the lowest voltage of a set-down pulse and the voltage of a scan pulse in a sub-field of the first sub-field group is set to be greater than the difference between lowest voltage of a set-down pulse and the voltage of a scan pulse of the second sub-field group.

The difference between the lowest voltage of a set-down pulse applied to the scan electrodes in the resent period and the voltage of a scan pulse applied to the scan electrodes in the address period in sub-fields comprised in the two sub-field groups can be the same for each group. For example, as shown in FIG. 9, assuming that the difference between the lowest voltage of a set-down pulse and the voltage of a scan pulse in the first sub-field is ΔV1 in each sub-field, the difference between the lowest voltage of a set-down pulse and the voltage of a scan pulse in other sub-field, i.e., a sub-field of the second sub-field group is ΔV2 in each sub-field. In this case, ΔV1 and ΔV2 have the relationship of ΔV1>ΔV2.

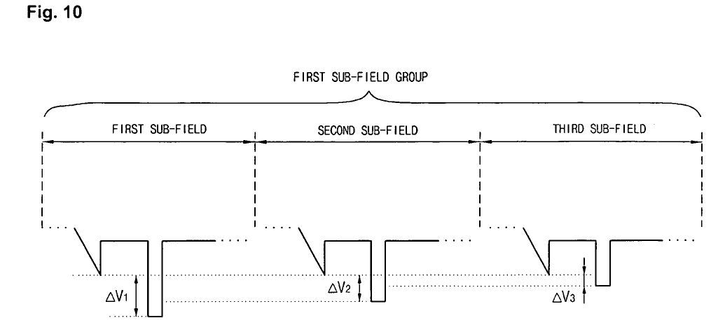

Unlike the above, in at least one of the above-mentioned two groups, i.e., the first sub-field group and the second sub-field group, the difference between the lowest voltage of a set-down pulse applied to the scan electrodes in the reset period and the voltage of a scan pulse applied to the scan electrodes in the address period can be set to be different for every sub-field. This driving waveform will be described with reference to FIG. 10.

FIG. 10 illustrates the difference between the lowest voltage of a set-down pulse and the voltage of a scan pulse within one sub-field group.

As shown in FIG. 10, the difference between the lowest voltage of a set-down pulse and the voltage of a scan pulse within one sub-field group is different on a sub-field basis. For example, assuming that the first sub-field group of FIG. 9 comprises first, second and third sub-fields, the difference between the lowest voltage of a set-down pulse and the voltage of a scan pulse in the first sub-field is ΔV1, the difference between the lowest voltage of a set-down pulse and the voltage of a scan pulse in the second sub-field is ΔV2, and the difference between the lowest voltage of a set-down pulse and the voltage of a scan pulse in the third sub-field is ΔV3. That is, the differences between the lowest voltage of a set-down pulse thend a voltage of a scan pulse in the first, second and third sub-fields are different.

As described above, in a group in which a difference between the lowest voltage of a set-down pulse applied to the scan electrodes in the reset period and the voltage of a scan pulse applied to the scan electrodes in the address period is different on a sub-field basis, i.e., the first sub-field group, the difference between the lowest voltage of a set-down pulse applied to the scan electrodes in the reset period and a voltage of a scan pulse applied to the scan electrodes in the address period is different can be increased as the weight decreases. The relationship ΔV1>ΔV2>ΔV3 is established.

As described above, a group in which the difference between the lowest voltage of a set-down pulse applied to the scan electrodes in the reset period and the voltage of a scan pulse applied to the scan electrodes in the address period is set to be greater than the difference between lowest voltage of a set-down pulse and the voltage of a scan pulse of other groups, i.e., the first sub-field group can comprise sub-fields using a number of sustain pulses that is smaller than a critical number. That is, this sub-field group is comprised of sub-fields with a low gray level.

In this case, the above-mentioned critical number can be 50% or less of the total number of sustain pulses used in one frame. The critical number can also be 30% or less of the total number of sustain pulses used in one frame.

As shown in FIG. 10, the difference between the lowest voltage of a set-down pulse and the voltage of a scan pulse is different in each of sub-fields comprised in the first sub-field group. Unlike the above, the difference between the lowest voltage of a set-down pulse and the voltage of a scan pulse in at least one of sub-fields comprised in the first sub-field group is different from the difference between lowest voltage of a set down pulse and the voltage of a scan pulse of the remaining sub-fields, and the difference between the lowest voltage of a set-down pulse and the voltage of a scan pulse in the remaining sub-fields within the first sub-field can be set to be the same. This case can be described by taking the case of FIG. 10 as an example, the difference between the lowest voltage of a set-down pulse and the voltage of a scan pulse in the first sub-field of the first sub-field group is ΔV1, and the difference between the lowest voltage of a set-down pulse and the voltage of a scan pulse in the remaining sub-fields of the first sub-field group, i.e., the second sub-field and the third sub-field is the same, i.e., ΔV2.

In conclusion, where one frame is divided into two sub-field groups and the difference between the lowest voltage of a set-down pulse and the voltage of a scan pulse in one of the two divided sub-field groups is set to be greater than the difference between lowest voltage of a set-down pulse and the voltage of a scan pulse of the other sub-field group, the difference between the lowest voltage of a set-down pulse and the voltage of a scan pulse can be different every sub-field within a sub-field group in which the difference between the lowest voltage of a set-down pulse and the voltage of a scan pulse is greater than the different between lowest voltage of a set-down pulse and the voltage of a scan pulse of the remaining sub-field groups, a difference between the lowest voltage of a set-down pulse and the voltage of a scan pulse in at least one sub-field can be different from the difference between lowest voltage of a set-down pulse and the voltage of a scan pulse of the remaining sub-fields within the same sub-field group, and the difference between the lowest voltage of a set-down pulse and the voltage of a scan pulse can be set to be the same in the entire sub-fields.

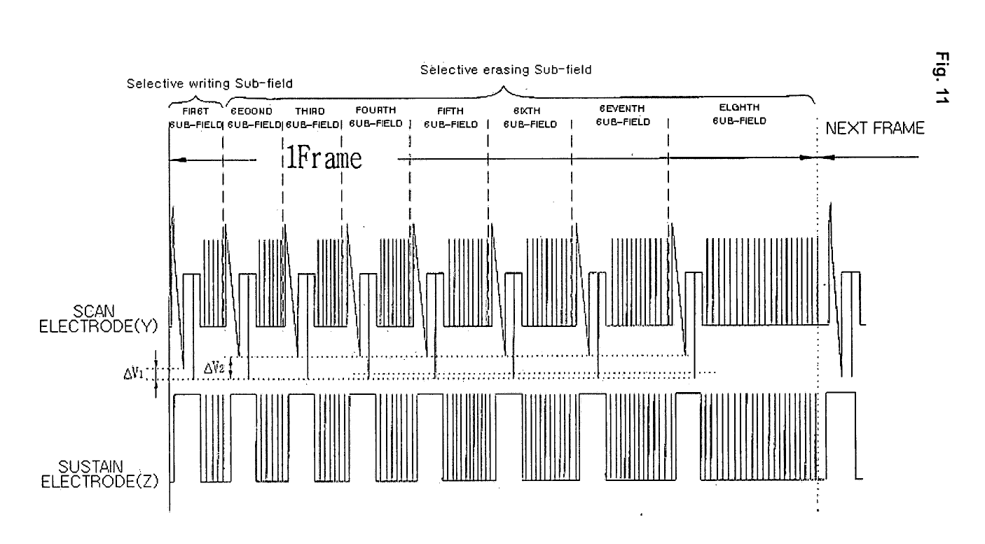

As shown and described above, all of the sub-fields of one frame are sub-fields of the selective writing mode. However, in the case where both sub-fields of the selective writing mode and selective erasing mode are comprised in one frame, the difference between the lowest voltage of a set-down pulse and the voltage of a scan pulse are controlled by considering the difference in the weight of a sub-field and sub-field mode. A driving method when sub-fields of one frame comprises sub-fields of the selective writing mode and sub-fields of the selective erasing mode as described above will be described with reference to FIG. 11.

FIG. 11 illustrates a driving method when sub-fields of one frame comprise sub-fields of the selective writing mode and sub-fields of the selective erasing mode.

As shown in FIG. 11, one frame comprise sub-fields of the selective writing mode and sub-fields of the selective erasing mode, and a difference between the lowest voltage of a set-down pulse applied to the scan electrodes in the reset period and the voltage of a scan pulse applied to the scan electrodes in the address period, in the selective erasing sub-field of the frame, is greater than the difference between lowest voltage of a set-down pulse and the voltage of a scan pulse of the selective writing sub-field.

For example, as shown in FIG. 11, where the first sub-field is a selective writing sub-field and the remaining sub-fields, i.e., from the second sub-field to the eighth sub-field (in this case, it is assumed that one frame consists of eight sub-fields) are a selective erasing sub-field, assuming that the difference between the lowest voltage of a set-down pulse and the voltage of a scan pulse in the selective erasing sub-field is ΔV2, the difference between the lowest voltage of a set-down pulse and the voltage of a scan pulse in the selective writing sub-field is ΔV1. They have the relationship of ΔV2>ΔV1.

The above-mentioned selective erasing mode is a method of displaying images in such a way that after the entire screen undergoes a write discharge to turn on the entire screen in the reset period, selected discharge cells are turned off in the address period, and only discharge cells, which are not selected by an address discharge, then experience a sustain discharge in the sustain period. A relatively small amount of wall charges are generated in the reset period since the size of a reset pulse is smaller than the difference between lowest voltage of a set-down pulse and the voltage of a scan pulse of selective writing mode. Accordingly, in a selective erasing sub-field where a relatively small amount of wall charges are generated in the reset period because the size of a reset pulse is small as described above, there is a high probability that an address discharge may become unstable compared to a selective writing sub-field. Thus, to accumulate a sufficient amount of wall charges within discharge cells in the address period, the difference between the lowest voltage of a set-down pulse and the voltage of a scan pulse, which is applied to the scan electrodes in the address period, in sub-fields of selective erasing mode, must be set to be greater than the difference between lowest voltage of a set-down pulse and the voltage of a scan pulse of sub-fields -of the selective writing mode.

As described in FIG. 11, the selective writing sub-field is set as the first sub-field and the remaining sub-fields, i.e., from the second sub-field to the eight sub-field are set as the selective erasing sub-fields. However, the aforementioned selective writing sub-field is not restricted to the first sub-field, but various modifications are possible such as that the first and second sub-fields can be set as the selective writing sub-fields.

In the case where one frame comprises a plurality of selective erasing sub-fields as described above, the difference between the lowest voltage of a set-down pulse applied to the scan electrodes in the reset period and the voltage of a scan pulse applied to the scan electrodes in the address period, in a plurality of selective erasing sub-fields, can be the same. That is, using FIG. as an example, the difference between the lowest voltage of a set-down pulse and the voltage of a scan pulse applied to the scan electrodes in the address period from the second sub-field, i.e., the selective erasing sub-field to the eighth sub-field are the same.

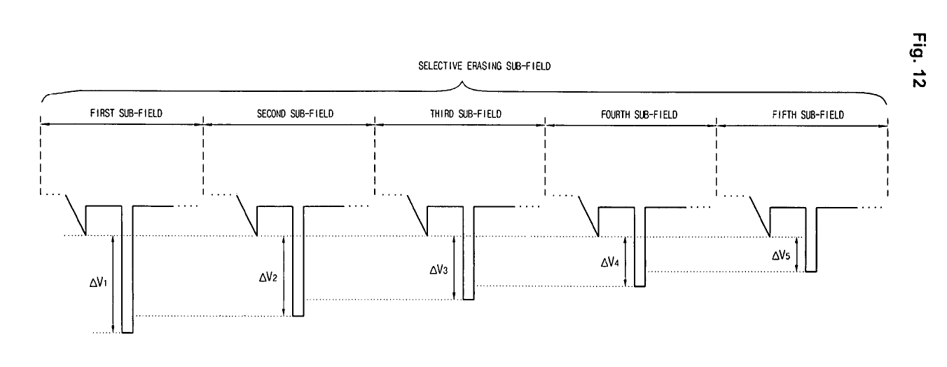

Unlike the above, however, where one frame comprises a plurality of selective erasing sub-fields, the difference between the lowest voltage of a set-down pulse applied to the scan electrodes in the reset period and the voltage of a scan pulse applied to the scan electrodes in the address period can be set to be different on a sub-field basis. This driving method will be described with reference to FIG. 12.

FIG. 12 illustrates the difference between the lowest voltage of a set-down pulse and the voltage of a scan pulse between selective erasing sub-fields.

As shown in FIG. 12, the difference between the lowest voltage of a set-down pulse and the voltage of a scan pulse applied to the scan electrodes in the address period from the second sub-field, i.e., the selective erasing sub-field to the eighth sub-field is different on a sub-field basis. That is, the difference between the lowest voltage of a set-down pulse and the voltage of a scan pulse in the second sub-field is ΔV1 and the difference between the lowest voltage of a set-down pulse and the voltage of a scan pulse in the third sub-field is ΔV2. the difference between the lowest voltage of a set-down pulse and the voltage of a scan pulse in the fourth sub-field is ΔV3 and the difference between the lowest voltage of a set-down pulse and the voltage of a scan pulse in the fifth sub-field is ΔV4. In this case, the relationship of ΔV1>ΔV2>ΔV3>ΔV4 is established.

In this case, between the plurality of selective erasing sub-fields, the lower the weight, the greater the difference between the lowest voltage of a set-down pulse applied to the scan electrodes in the reset period and the voltage of a scan pulse applied to the scan electrodes in the address period.

As shown and described in FIG. 12, the difference between the lowest voltage of a set-down pulse and the voltage of a scan pulse is different for every selective erasing sub-field. Unlike the above, the difference between the lowest voltage of a set-down pulse and the voltage of a scan pulse in at least one of the selective erasing sub-fields can be set to be different from the difference between lowest voltage of a set-down pulse and the voltage of a scan pulse of the remaining sub-fields, and the difference between the lowest voltage of a set-down pulse and the voltage of a scan pulse in the remaining selective erasing sub-fields can be set to be the same. This case is described by taking FIG. 12 as an example. Assuming that the difference between the lowest voltage of a set-down pulse and the voltage of a scan pulse in the second sub-field of the selective erasing sub-fields is ΔV1, a difference between the lowest voltage of a set-down pulse and a voltage of a scan pulse in the remaining sub-fields, i.e., from the third sub-field to the eighth sub-field is the same, i.e., ΔV2.

In conclusion, where the difference between the lowest voltage of a set-down pulse and the voltage of a scan pulse in selective erasing sub-fields comprised in one frame is set to be greater than the difference between lowest voltage of a set-down pulse and the voltage of a scan pulse of selective writing sub-fields, the difference between the lowest voltage of a set-down pulse and the voltage of a scan pulse in these selective erasing sub-fields can be different for every selective erasing sub-field, the difference between the lowest voltage of a set-down pulse and the voltage of a scan pulse in at least one selective erasing sub-field can be different from the difference between lowest voltage of a set-down pulse and the voltage of a scan pulse of the remaining selective erasing sub-fields, or a difference between the lowest voltage of a set-down pulse and a voltage of a scan pulse can be set to be the same in all of the selective erasing sub-fields.

As described above, the difference between the lowest voltage of a set-down pulse and the voltage of a scan pulse in a sub-field with a low gray level or a selective erasing sub-field having a relatively low voltage of a reset pulse is set to be greater than the difference between lowest voltage of a set-down pulse and the voltage of a scan pulse of the remaining sub-fields. The amount of wall charges accumulated within discharge cells becomes relatively less. Accordingly, there are advantages in that address discharges are prevented from becoming unstable, deterioration of address jitter is prevented and sustain discharges are stabilized.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A plasma display apparatus, comprising:
a plasma display panel on which images comprised of a frame are displayed by means of a combination of at least one or more sub-fields in which driving pulse are applied to address electrode, scan electrode and sustain electrode in a reset period, an address period and a sustain period;
a scan driver for driving the scan electrode; and
a scan pulse controller for controlling the scan driver to ensure that a difference between the voltage of a set-down pulse applied to the scan electrode in the reset period and a voltage of a scan pulse applied to the scan electrode in the address period, in one of sub-fields of the frame, is different from a difference between the voltage of a set-down pulse and the voltage of a scan pulse for each of the remaining sub-fields.

2. The plasma display apparatus as claimed in claim 1, wherein the voltage of scan pulse is constant.

3. The plasma display apparatus as claimed in claim 1, wherein the voltage of set-down pulse is the lowest voltage.

4. The plasma display apparatus as claimed in claim 1, wherein the difference between the voltage of the set-down pulse and the voltage of the scan pulse is controlled according to a gray value of a subfield.

5. The plasma display apparatus as claimed in claim 4, wherein the difference between the voltage of the set-down pulse and the voltage of the scan pulse in any subfield of three low gray level subfields is greater than the difference between the voltage of the set-down pulse and the voltage of the scan pulse in remaining subfields.

6. The plasma display apparatus as claimed in claim 4 or 5, wherein the difference between the voltage of the set-down pulse and the voltage of the scan pulse is controlled according to a number of sustain pulse in a subfield.

7. The plasma display apparatus as claimed in claim 6, the number of the sustain pulse in the subfield is 50% or less of a total number of sustain pulses used in one frame.

8. The plasma display apparatus as claimed in claim 7, the number of the sustain pulse in the subfield is 30% or less of a total number of sustain pulses used in one frame.

9. The plasma display apparatus as claimed in claim 1, wherein the sub-fields of the frame are divided into two subfield groups, wherein the scan pulse controller controls a difference between the voltage of a set-down pulse and the voltage of a scan pulse in a sub-field of at least one of the two subfield groups, to be greater than a difference between the voltage of the set-down pulse and the voltage of the scan pulse for each of the remaining sub-fields of the other group.

10. The plasma display apparatus as claimed in claim 9, each of the two subfield groups comprise three low gray level subfields

11. The plasma display apparatus as claimed in claim 9, wherein in a group in which a difference between the voltage of a set-down pulse and the voltage of a scan pulse is great, of the two subfield groups, the scan pulse controller -controls a difference between the voltage of a set-down pulse and the voltage of a scan pulse, in one of sub-fields, to be different from the difference between lowest voltage of a set-down pulse and the voltage of a scan pulse of the remaining sub-fields.

12. The plasma display apparatus as claimed in claim 9, wherein in a group in which a difference between the voltage of a set-down pulse and a voltage of a scan pulse is great, of the two subfield groups, the scan pulse controller controls a difference between the voltage of a set-down pulse and the voltage of a scan pulse to be different on a sub-field basis.

13. The plasma display apparatus as claimed in claim 12, wherein in a group in which a difference between the voltage of a set-down pulse and the voltage of a scan pulse is different on a sub-field basis, the scan pulse controller controls a difference between the voltage of a set-down pulse and the voltage of a scan pulse to increase as the weight decreases.

14. The plasma display apparatus as claimed in claim 9, wherein the predetermined number of sub-fields comprises sub-fields in which sustain pulses are allowed, and wherein the number of the sustain pulses allowed in the sub-fields is less than a critical number.

15. The plasma display apparatus as claimed in claim 14, wherein the critical number is 50% or less, of a total number of sustain pulses used in one frame.

16. The plasma display apparatus as claimed in claim 15, wherein the critical number is 30% or less, of the total number of sustain pulses used in one frame.

17. The plasma display apparatus as claimed in claim 1, wherein the frame comprises a selective writing sub-field and a selective erasing sub-field, wherein the scan pulse controller controls a difference between the voltage of a set-down pulse and the voltage of a scan pulse in the selective erasing sub-field of the sub-fields of the frame, to be greater than a difference between the voltage of a set-down pulse and the voltage of a scan pulse in the selective writing sub-field.

18. The plasma display apparatus as claimed in claim 17, wherein the frame comprises a plurality of selective erasing sub-fields, wherein the scan pulse controller controls a difference between the voltage of a set-down pulse and the voltage of a scan pulse applied to the scan electrodes in the address period to be the same in the plurality of selective erasing sub-fields.

19. The plasma display apparatus as claimed in claim 17, wherein the frame comprises a plurality of selective erasing sub-fields, wherein the scan pulse controller controls a difference between the voltage of a set-down pulse and the voltage of a scan pulse in the address period, in one of the plurality of selective erasing sub-fields, to be different from a difference between the voltage of a set-down pulse and the voltage of a scan pulse of the remaining selective erasing sub-fields.

20. The plasma display apparatus as claimed in claim 17, wherein the frame comprises a plurality of selective erasing sub-fields, wherein the scan pulse controller controls a difference between the voltage of a set-down pulse and the voltage of a scan pulse to be different for every sub-field in the plurality of selective erasing sub-fields.

21. The plasma display apparatus as claimed in claim 20, wherein the scan pulse controller controls a difference between the voltage of a set-down pulse and the voltage of a scan pulse to increase as the weight decreases in order of a higher weight in the plurality of selective erasing sub-fields.

22. A plasma display apparatus, comprising:
a plasma display panel on which images comprised of a frame are displayed by means of a combination of at least one or more sub-fields in which driving pulse are applied to address electrode, scan electrode and sustain electrode in a reset period, an address period and a sustain period;
a scan driver for driving the scan electrode; and
a scan pulse controller for controlling the scan driver to ensure that a voltage of a scan pulse applied to the scan electrode in address period, in one of subfields of the frame, is not equal to the voltage of a scan pulse for each of the remaining subfields.

23. An apparatus for driving a plasma display panel on which images comprised of a frame are displayed by means of a combination of at least one or more sub-fields in which driving pulses are applied to address electrode, scan electrode and sustain electrode in a reset period, an address period and a sustain period, the apparatus comprising:
a scan driver for driving the scan electrode; and
a scan pulse controller for controlling the scan driver to set a difference between a voltage of a set-down pulse and a voltage of a scan pulse, in one of sub-fields of the frame, to be different from a voltage of a set-down pulse and a voltage of a scan pulse of the remaining sub-fields.

24. A plasma display panel on which images comprised of a frame are displayed by means of a combination of at least one or more sub-fields in which driving pulses are applied to address electrode, scan electrode and sustain electrode in a reset period, an address period and a sustain period,
wherein a difference between a voltage of a set-down pulse and a voltage of a scan pulse, in one of sub-fields of the frame, is set to be different from a voltage of a set-down pulse and a voltage of a scan pulse of the remaining sub-fields.

25. A method of driving a plasma display apparatus on which images comprised of a frame are displayed by means of a combination of at least one or more sub-fields, the method comprising:
setting a difference between a voltage of a set-down pulse applied to the scan electrode in the reset period of subfield and a voltage of a scan pulse applied to the scan electrode in the address period of a subfield of the frame, to be different from a voltage of a set-down pulse and a voltage of a scan pulse for each of the remaining sub-fields.

26. A method of driving a plasma display apparatus on which images comprised of a frame are displayed by means of a combination of at least one or more sub-fields, the method comprising:
setting a voltage of a scan pulse applied to the scan electrode in one of sub-fields of the frame to be different from a voltage of a set-down pulse and a voltage of a scan pulse for each of the remaining sub-fields.
